(19) United States
(12) Patent Application Publication
(10) Pub. No.: US 2021/0191682 A1
(43) Pub. Date: Jun. 24, 2021

(54) METHOD AND SYSTEM FOR ASSOCIATING AND DISPLAYING CONTENT AND LIST OF CONTENTS ON DUAL SCREEN

(71) Applicant: NAVER Corporation, Seongnam-si (KR)

(72) Inventors: Yeongje KIM, Seongnam-si (KR); Hanno LEE, Seongnam-si (KR); Byungsoo KIM, Seongnam-si (KR); Jihyun HWANG, Seongnam-si (KR); Jung Hee BAEK, Seongnam-si (KR); Jinah PARK, Seongnam-si (KR); Eunbi JOE, Seongnam-si (KR); Hyoung Jung KIM, Seongnam-si (KR)

(21) Appl. No.: 17/130,761

(22) Filed: Dec. 22, 2020

(30) Foreign Application Priority Data
Dec. 23, 2019 (KR) 10-2019-0172699

(51) Int. Cl. G06F 3/14; G06F 3/0485; G06T 11/00

(52) U.S. Cl. CPC G06F 3/1431; G06T 11/001; G06F 3/0485

(57) ABSTRACT

A method of providing content includes displaying content on a first screen and a list of contents on a second screen of a dual screen, and highlighting, in the list of contents, an item indicative of content now being displayed on the first screen, in a forward moving mode in which content corresponding to the list of contents is continuously displayed on the first screen in response to a scrolling input to the first screen.

### CROSS-REFERENCE TO RELATED APPLICATION

This application claims priority under 35 U.S.C. § 119 to Korean Patent Application No. 10-2019-0172699 filed on Dec. 23, 2019, which is incorporated herein by reference in its entirety.

### BACKGROUND OF THE INVENTION

### 1. Technical Field

The following description relates to technology for associating and displaying content and a list of contents.

### 2. Description of the Related Art

Personal terminals are commonly used due to the developments in digital technology. Various services using the personal terminals are provided.

Examples of the personal terminals include a smartphone, a tablet, a wearable device, and a notebook. The personal terminals have various functions, such as a data communication function, a voice communication function, a camera function, a multimedia player function, and a payment function.

As an example of terminal functions, technology for providing cartoon in a mobile digital content form is disclosed in Korean Patent Application Publication No. 10-2011-0123393 (Nov. 15, 2011).

### BRIEF SUMMARY OF THE INVENTION

In accordance with an embodiment of the present invention, content may be displayed on one screen and a list of contents may be displayed on the other screen of a dual screen.

Furthermore, a list of contents may be highlighted and displayed on the other screen with respect to content displayed on the one screen.

The other screen may be automatically scrolled and displayed when the one screen is scrolled by associating content and an episode list displayed on the other screen.

In an aspect, there is provided a method of providing content executed in a computer device. The computer device includes at least one processor configured to execute computer-readable instructions included in a memory. The method includes displaying, by the at least one processor, content on a first screen and a list of contents on a second screen of a dual screen included in the computer device, and highlighting, by the at least one processor, an item indicative of content now being displayed on the first screen in the list of contents in a forward moving mode in which a plurality of pieces of content included in the list of contents is continuously displayed on the first screen in response to a scrolling input to the first screen.

According to an aspect, displaying a list of contents may include displaying the content on the first screen and displaying the list of contents on the second screen, through a web browser supporting a dual screen function.

According to another aspect, highlighting an item indicative of content may include moving the highlight in the list of contents from a previous item indicative of previous content to a next item indicative of next content, when the previous content moves onto the next content in response to the scrolling input to the first screen.

According to still another aspect, highlighting an item indicative of content may include adjusting the list of contents by scrolling the list of contents so that the highlight is located within a given range using at least one reference line determined in the second screen.

According to still another aspect, highlighting an item indicative of content may include scrolling the list of contents by a maximum length at timing at which the highlight in the list of contents reaches a critical location on the second screen.

According to still another aspect, highlighting an item indicative of content may include scrolling the list of contents by a unit length whenever the highlight in the list of contents moves on the second screen.

According to still another aspect, highlighting an item indicative of content may include scrolling the list of contents in response to a scrolling input to the second screen, and adjusting the list of contents by scrolling the list of contents so that the highlight is located within a given range using at least one reference line determined in the second screen, when an additional scrolling input for the second screen is not present for a given time or a scrolling input to the first screen is present.

According to still another aspect, the method may further include displaying, by the at least one processor, the list of contents on the second screen in a page unit if the list of contents is composed of a plurality of pages, and controlling, by the at least one processor, the list of contents on the second screen so that a previous page automatically moves onto a next page in the forward moving mode.

In an embodiment, there is provided a non-transitory computer-readable recording medium in which a program for executing the method of providing content in a computer is written.

In an embodiment, there is provided a computer device including at least one processor implemented to execute computer-readable instructions included in a memory. The at least one processor includes a display unit configured to display content on a first screen and a list of contents on a second screen of a dual screen included in the computer device, and an association unit configured to highlight, in the list of contents, an item indicative of content now being displayed on the first screen, in a forward moving mode in which a plurality of pieces of content included in the list of contents is continuously displayed on the first screen in response to a scrolling input to the first screen.

### BRIEF DESCRIPTION OF THE DRAWINGS

FIG. 1 is a diagram illustrating an example of a network environment according to an embodiment of the present disclosure.

FIG. 2 is a block diagram for describing internal components of an electronic device and a server according to an embodiment of the present disclosure.

FIG. 3 is a diagram illustrating an example of components which may be included in the processor of the electronic device according to an embodiment of the present disclosure.

FIG. 4 is a flowchart illustrating an example of a method which may be performed by the electronic device according to an embodiment of the present disclosure.

FIG. 5 illustrates an example in which a dual screen is separated and used according to an embodiment of the present disclosure.

FIGS. 6 and 7 are exemplary diagrams for describing a content scrolling method according to an embodiment of the present disclosure.

FIGS. 8 and 9 are exemplary diagrams for describing a process of highlighting a content item in a list of contents according to an embodiment of the present disclosure.

FIGS. 10 to 13 are exemplary diagrams for describing a process of controlling highlighting of an item in a list of contents according to an embodiment of the present disclosure.

FIGS. 14 and 15 are exemplary diagrams for describing a process of displaying a list of contents composed of a plurality of pages according to an embodiment of the present disclosure.

### DETAILED DESCRIPTION OF THE INVENTION

Hereinafter, embodiments of the present disclosure are described in detail with reference to the accompanying drawings.

Embodiments of the present disclosure relate to technology for associating and displaying content and a list of contents.

Embodiments including contents specifically disclosed in this specification may display content on one screen and a list of contents on the other screen of a dual screen, and may highlight and display the list of contents on the other screen with respect to the content displayed on one screen, and thus may provide a user interface (UI) for effectively displaying content on the dual screen and a user experience optimized for the dual screen.

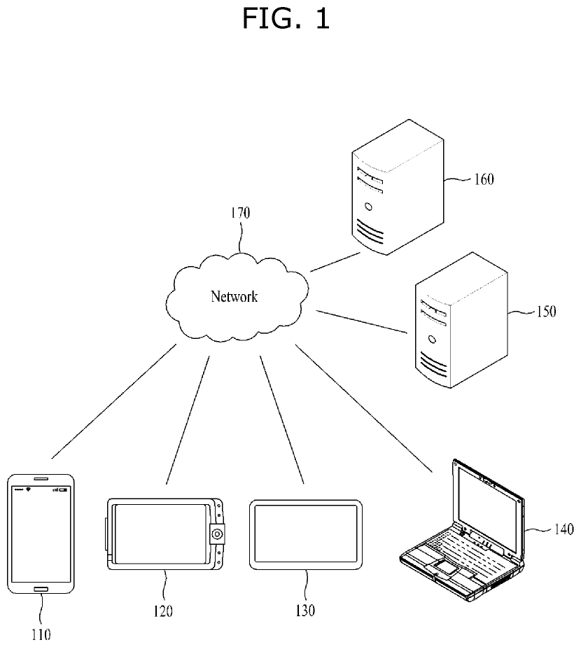

FIG. 1 is a diagram illustrating an example of a network environment according to an embodiment of the present disclosure. The network environment of FIG. 1 illustrates an example including a plurality of electronic devices 110, 120, 130, and 140, a plurality of servers 150 and 160, and a network 170. In FIG. 1, the number of electronic devices or the number of servers, that is, an example for describing the present disclosure, is not limited to that of FIG. 1.

Each of the plurality of electronic devices 110, 120, 130 and 140 may be a stationary terminal or a mobile terminal implemented as a computer system. For example, the plurality of electronic devices 110, 120, 130 and 140 may include a smartphone, a mobile phone, a navigation device, a computer, a laptop computer, a device for digital broadcasting, personal digital assistants (PDA), a portable multimedia player (PMP), a tablet PC, a game console, a wearable device, an Internet of things (IoT) device, a virtual reality (VR) device, an augmented reality (AR) device. For example, in FIG. 1, a shape of a smartphone is illustrated as being an example of the electronic device 110. However, in embodiments of the present disclosure, the electronic device 110 may mean one of various physical computer devices capable of communicating with other electronic devices 120, 130 and 140 and/or the servers 150 and 160 over the network 170 substantially using a wireless or wired communication method.

The communication method is not limited, and may include short-distance wireless communication between devices in addition to communication methods using communication networks (e.g., a mobile communication network, wired Internet, wireless Internet, a broadcasting network and a satellite network) which may be included in the network 170. For example, the network 170 may include one or more given networks of a personal area network (PAN), a local area network (LAN), a campus area network (CAN), a metropolitan area network (MAN), a wide area network (WAN), a broadband network (BBN), and the Internet. Furthermore, the network 170 may include one or more of network topologies, including a bus network, a star network, a ring network, a mesh network, a star-bus network, and a tree or hierarchical network, but is not limited thereto.

Each of the servers 150 and 160 may be implemented as a computer device or a plurality of computer devices, which provides an instruction, a code, a file, content, or a service through communication with the plurality of electronic devices 110, 120, 130 and 140 over the network 170. For example, the server 150 may be a system that provides a first service to the plurality of electronic devices 110, 120, 130, and 140 connected thereto over the network 170. The server 160 may be a system that provides a second service to the plurality of electronic devices 110, 120, 130, and 140 connected thereto over the network 170. As a more detailed example, the server 150 may provide the plurality of electronic devices 110, 120, 130, and 140 with a service (e.g., a content providing service), targeted by a corresponding application, as the first service through an application as a computer program installed and driven in the plurality of electronic devices 110, 120, 130, and 140. For another example, the server 160 may provide, as the second service, a service for distributing a file for installing and driving the aforementioned application to the plurality of electronic devices 110, 120, 130, and 140.

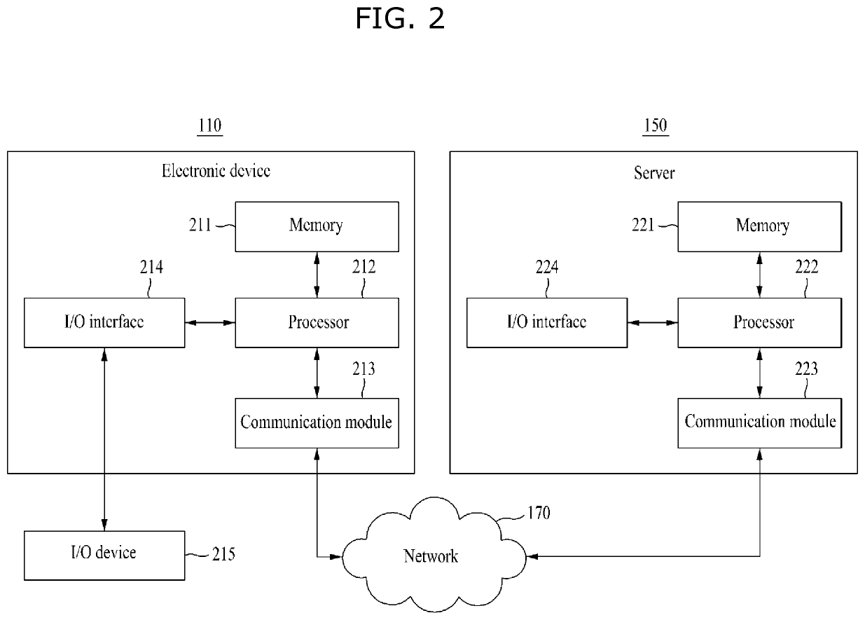

FIG. 2 is an example of the electronic device and describes internal components of the electronic device 110 and the server 150. Furthermore, each of other electronic devices 120, 130, and 140 or the server 160 may have the same or similar components as those of the electronic device 110 or the server 150.

The electronic device 110 and the server 150 may include memories 211 and 221, processors 212 and 222, communication modules 213 and 223, and input and output (I/O) interfaces 214 and 224, respectively. Each of the memories 211 and 221 is a non-transitory computer-readable recording medium, and may include permanent mass storage devices, such as a random access memory (RAM), a read only memory (ROM), a disk drive, a solid state drive (SSD), and a flash memory. A separate permanent mass storage device, such as a ROM, an SSD, a flash memory or a disk drive, different from the memory 211, 221, may also be included in the electronic device 110 or the server 150. Furthermore, the memory 211, 221 may store an operating system and at least one program code (e.g., a code for a browser installed and driven in the electronic device 110 or an application installed in the electronic device 110 in order to provide a specific service). Such software components may be loaded from a separate computer-readable recording medium different from the memory 211, 221. Such a separate computer-readable recording medium may include computer-readable recording media, such as a floppy drive, a disk, a tape, a DVD/CD-ROM drive, or a memory card. In other embodiments, the software components may be loaded onto the memory 211, 221 through the communication module 213, 223 not a computer-readable recording medium. For example, at least one program may be loaded onto the memory 211, 221 based on a computer program (e.g., the aforementioned application) installed by files provided, over the network 170, by developers or a file distribution system (e.g., the aforementioned server 160) that distributes the file for installing an application.

The processor 212, 222 may be configured to process instructions of a computer program by performing basic arithmetic, logic and I/O operations. The instructions may be provided from the memory 211, 221 or the communication module 213, 223 to the processor 212, 222. For example, the processor 212, 222 may be configured to execute received instructions based on a program code stored in a recording device, such as the memory 211, 221.

The communication module 213, 223 may provide a function for communication between the electronic device 110 and the server 150 over the network 170, and may provide a function that enables the electronic device 110 and/or the server 150 to communicate with another electronic device (e.g., the electronic device 120) or another server (e.g., the server 160). For example, a request generated by the processor 212 of the electronic device 110 in response to a program code stored in a recording device, such as the memory 211, may be transmitted to the server 150 over the network 170 under the control of the communication module 213. Inversely, a control signal, an instruction, content, a file, etc. provided under the control of the processor 222 of the server 150 may be received by the electronic device 110 through the communication module 213 of the electronic device 110 through the communication module 223 and the network 170. For example, a control signal, an instruction, content, a file, etc. of the server 150 received through the communication module 213 may be transmitted to the processor 212 or the memory 211. Content, a file, etc. of the server 150 received through the communication module 213 may also be stored in a storage medium (the aforementioned permanent storage device) which may be further included in the electronic device 110 other than the memory 211.

The I/O interface 214 may be means for interfacing with the I/O device 215. For example, the input device of the I/O device 215 may include devices, such as a keyboard, a mouse, a microphone, and a camera. The output device of the I/O device 215 may include devices, such as a display, a speaker, and a haptic feedback device. For another example, the I/O interface 214 may be means for interfacing with a device in which functions for an input and an output are integrated into one, such as a touch screen. The I/O device 215, together with the electronic device 110, may be configured into a single device. Furthermore, the I/O interface 224 of the server 150 may be means for interfacing with a device (not illustrated) for an input or output, which is connected to the server 150 or which may be included in the server 150. As a more detailed example, when the processor 212 of the electronic device 110 processes instructions of a computer program loaded onto the memory 211, a service screen or content configured using data provided by the server 150 or the electronic device 120 may be displayed on a display through the I/O interface 214.

Furthermore, in other embodiments, each of the electronic device 110 and the server 150 may include more components than those of FIG. 2. For example, the electronic device 110 may be implemented to include at least some of the aforementioned I/O devices 215 or may further include other components, such as a transceiver, a global positioning system (GPS) module, a camera, various sensors, and a database. As a more detailed example, if the electronic device 110 is a smart phone, the electronic device 110 may be implemented to further include various components, such as an acceleration sensor, a gyro sensor, a camera module, various physical buttons, buttons using a touch panel, an I/O port, and a vibrator for vibration which are included in the smart phone.

Hereinafter, detailed embodiments of a method and a system for associating and displaying content and a list of contents on a dual screen are described.

In this specification, content is information on the web, and may mean various types of information generated in various forms, such as text, an image, voice, and video, or contents thereof. For example, content may be an Internet cartoon, also known as webtoon, serialized through the Internet, and composed of a plurality of episodes. However, content is not limited to a webtoon, and may include all of continuous projects having a series form. For another example, content may mean product information, that is, a shopping target on the Internet. Content may be an information unit provided through services, such as news, mail, search and music, in addition to a webtoon or a shopping product.

Hereinafter, detailed embodiments are described by taking webtoon content as a representative example of content, but the present disclosure is not limited thereto and may be applied to all types of content which may be listed.

Furthermore, in the present embodiment, the electronic device 110 includes a dual screen as display means, and may include a first screen playing a role of a main screen and a second screen playing a role of an auxiliary screen. For example, the dual screen may be implemented as a multi-screen in which the first screen and the second screen are configured as separate displays. For another example, the dual screen may be implemented using the first screen and the second screen which are divided into different display areas in one display. For example, the dual screen may be implemented as a simultaneous screen on which the second screen is overlaid and displayed in some areas of the first screen, such as a picture in picture (PIP).

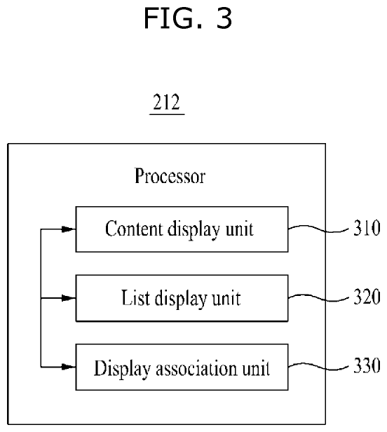

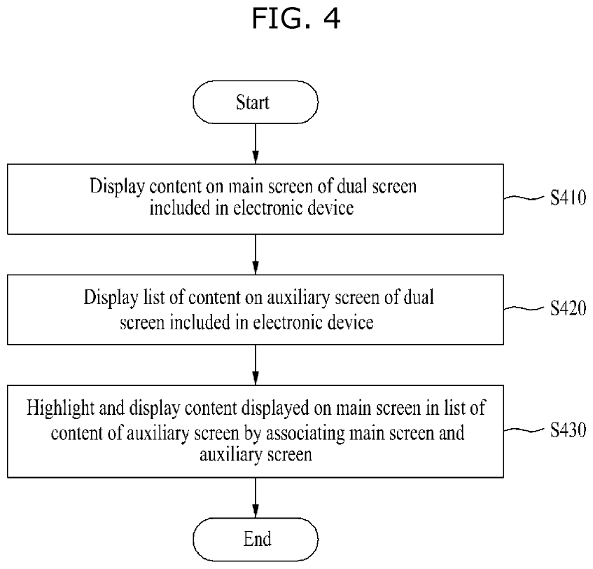

FIG. 3 is a diagram illustrating an example of components which may be included in the processor 212 of the electronic device 110 according to an embodiment of the present disclosure. FIG. 4 is a flowchart illustrating an example of a method which may be performed by the electronic device 110 according to an embodiment of the present disclosure.

A content providing system implemented using a computer may be configured in the electronic device 110 according to the present embodiment. For example, the content providing system may be implemented in the form of a program that independently operates or may be configured in an in-app form of a specific application and implemented to operate on the specific application, and may provide webtoon content and a list of contents through interoperation with the server 150 in some cases.

The content providing system implemented in the electronic device 110 may perform a method of providing content illustrated in FIG. 4, based on instructions provided by an application installed in the electronic device 110.

In order to perform the method of providing content of FIG. 4, the processor 212 of the electronic device 110 may include a content display unit 310, a list display unit 320, and a display association unit 330 as components, as illustrated in FIG. 3. In some embodiment, the components of the processor 212 may be selectively included in the processor 212 or excluded therefrom. Furthermore, in some embodiments, the components of the processor 212 may be separated or merged for the expressions of functions of the processor 212.

The processor 212 and the components of the processor 212 may control the electronic device 110 to perform steps S410 to S430 included in the method of providing content of FIG. 4. For example, the processor 212 and the components of the processor 212 may be implemented to execute instructions according to a code of an operating system and a code of at least one program included in the memory 211.

In this case, the components of the processor 212 may be expressions of different functions of the processor 212 performed by the processor 212 in response to instructions provided by a program code stored in the electronic device 110 (e.g., instructions provided by an application driven in the electronic device 110). For example, the content display unit 310 may be used as a functional expression of the processor 212, which controls the electronic device 110 in response to the aforementioned instructions so that the electronic device 110 displays webtoon content.

The processor 212 may read required instructions from the memory 211 onto which instructions related to control of the electronic device 110 have been loaded. In this case, the read instructions may include instructions for controlling the processor 212 to execute steps S410 to S430 to be described later. Steps S410 to S430 to be described later may be performed in order different from the order illustrated in FIG. 4, and some of the steps may be omitted or the steps may further include an additional process.

Referring to FIG. 4, at step S410, the content display unit 310 may receive webtoon content (hereinafter referred to as a “webtoon”) from the server 150, and may display the received webtoon on a first screen (hereinafter referred to as a “main screen”), that is, one of two screens constituting a dual screen. A web browser that supports a dual screen function is installed in the electronic device 110. The content display unit 310 may receive a webtoon from the server 150 through the web browser installed in the electronic device 110, and may display the received webtoon on the main screen. In this case, the content display unit 310 may display the received webtoon in a way to scroll the webtoon in response to a scroll input to the main screen from a user. An example of the scrolling input may correspond to a touch-based user input to a screen of the electronic device 110. For another example, a movement of a gaze of a user for a screen may be recognized using the front camera of the electronic device 110, and may be used as a user input for scrolling. For still another example, a movement (e.g., a slope) of the electronic device 110 may be detected using a sensor (e.g., an acceleration sensor or a gyro sensor) included in the electronic device 110, and may be used as a user input for scrolling. A webtoon scrolling method may include an up and down (or vertical) scrolling method or a left and right (or horizontal) paging (or flicking) method depending on a webtoon configuration or a production format. Well known technologies may be used as detailed methods of controlling the scrolling of a webtoon.

At step S420, the list display unit 320 may receive, from the server 150, a list of contents (hereinafter referred to as an “episode list”) including the webtoon displayed on the main screen, and may display the received list on a second screen (hereinafter referred to as an “auxiliary screen”), that is, the other of the two screens constituting the dual screen. The web browser installed in the electronic device 110 may support a dual screen function. In this case, the dual screen function enables a simultaneous use in which two applications are simultaneously driven and a separate use in which one application UI is extended to two screens. In the case of a separate use, an episode list may be displayed on the auxiliary screen, and content may be displayed on the main screen. For example, when services, such as webtoon, shopping, news, mail, search and music are used, an episode list may be displayed on the auxiliary screen. When specific content is selected in an episode list, the selected content may be displayed on the main screen. Alternatively, an episode list may be displayed on the main screen, and content may be displayed on the auxiliary screen.

When a user of the electronic device 110 selects a forward moving mode in a webtoon service, the processor 212 may display a webtoon on the main screen and display an episode list on the auxiliary screen. In the webtoon service, the forward moving mode is a continuous function of scrolling without the need for a user to select episodes of webtoons one by one or to input a separate UI for moving to a next episode when watching webtoons, but is a method for enabling a user to naturally move from a previous episode to the next episode through scrolling and to continuously watch webtoons.

At step S430, the display association unit 330 may highlight, in the episode list on the auxiliary screen, the episode of the webtoon displayed on the main screen by associating the main screen and auxiliary screen of the dual screen through the web browser installed in the electronic device 110. In other words, the display association unit 330 may highlight an item indicative of the episode of a webtoon displayed on the main screen, among episode items included in the episode list on the auxiliary screen. A method of highlighting an episode item corresponding to a webtoon currently being watched or viewed, on the main screen may include differently displaying display elements (e.g., a color, size, thickness and background of text) constituting the episode item from the other episode items, and may indicate a separate layer or indicator in the episode item corresponding to the watched webtoon. In addition, widely known methods may be used as a method of highlighting the episode item corresponding to the watched webtoon.

In the forward moving mode, when a previous episode moves onto the next episode in response to scrolling of the main screen, the display association unit 330 may move a highlight indicative of a webtoon, now being watched in the episode list, from a previous episode item to the next episode item. If additional scrolling is performed in the last scene of a previous episode, the content display unit 310 invokes the next episode and displays the next episode on the main screen. At this time, the display association unit 330 may move the highlight in the episode list, displayed on the auxiliary screen through the list display, from a previous episode item to the next episode item unit 320.

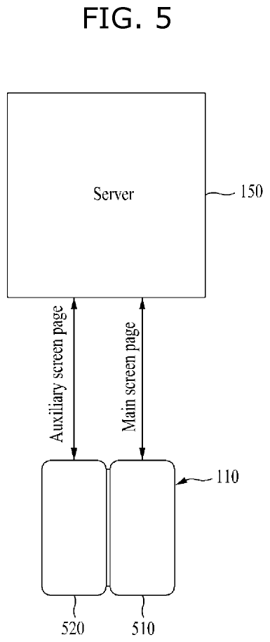

FIG. 5 illustrates an example in which a dual screen is separated and used according to an embodiment of the present disclosure.

Referring to FIG. 5, the server 150 may provide a content providing service to the electronic device 110 in which a web browser supporting a dual screen function is installed. In response to a request from the electronic device 110, the server 150 may provide an auxiliary screen page to be exposed to an auxiliary screen 520 of a dual screen, and may provide a main screen page to be exposed to a main screen 510 as a link selected in the auxiliary screen page. For example, the electronic device 110 may receive a page, including an episode list, from the server 150 through the web browser supporting the dual screen function, may display the page on the auxiliary screen 520, may receive content, specified in the episode list, from the server 150, and may display the received content on the main screen 510. In the forward moving mode, content may be invoked from the first episode or a continuous episodes of an episode list and displayed on the main screen 510. Thereafter, episodes may be sequentially invoked in response to a scrolling input to the main screen 510 from a user, and may be displayed on the main screen 510.

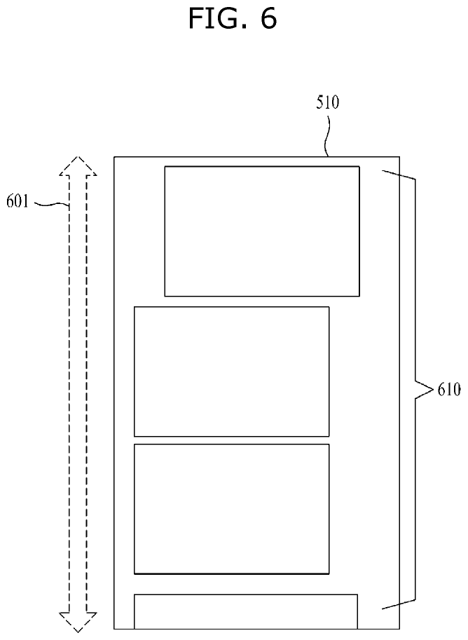

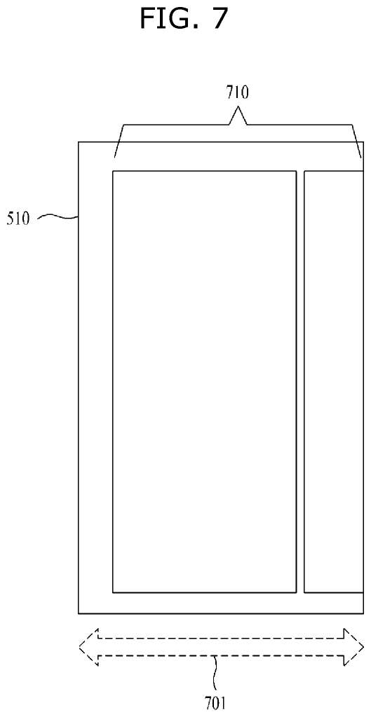

FIGS. 6 and 7 are exemplary diagrams for describing a webtoon scrolling method according to an embodiment of the present disclosure.

Referring to FIG. 6, the processor 212 of the electronic device 110 may display webtoons 610 on the main screen 510 using a vertical (601) scrolling method. The processor 212 of the electronic device 110 may display the webtoons 610 whose story is developed from top to bottom using an up and down scrolling method.

Referring to FIG. 7, the processor 212 of the electronic device 110 may display webtoons 710 on the main screen 510 using a horizontal (701) scrolling method. The processor 212 of the electronic device 110 may display the webtoons 710 whose story is developed from left to right using a left and right paging method.

Hereinafter, a detailed process of providing webtoons using the vertical scrolling method is described, but another scrolling method may also provide webtoons through a process identical or similar to a method to be described later.

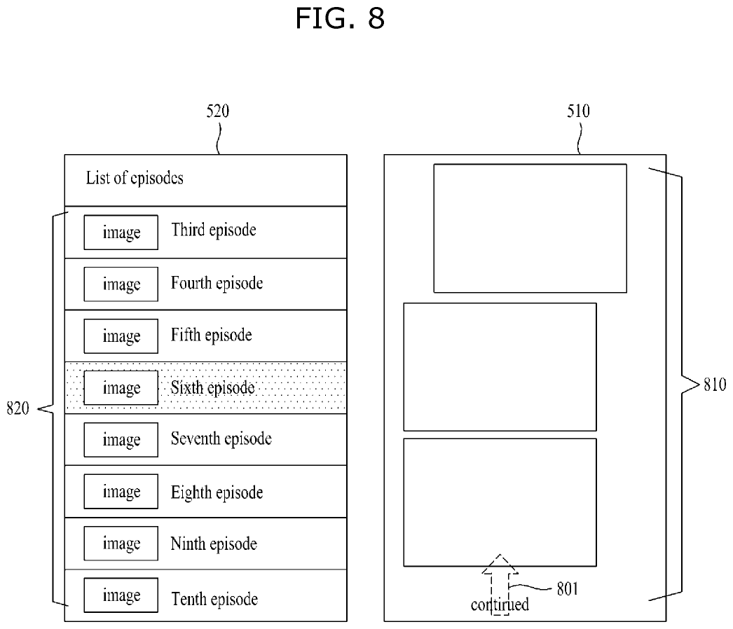

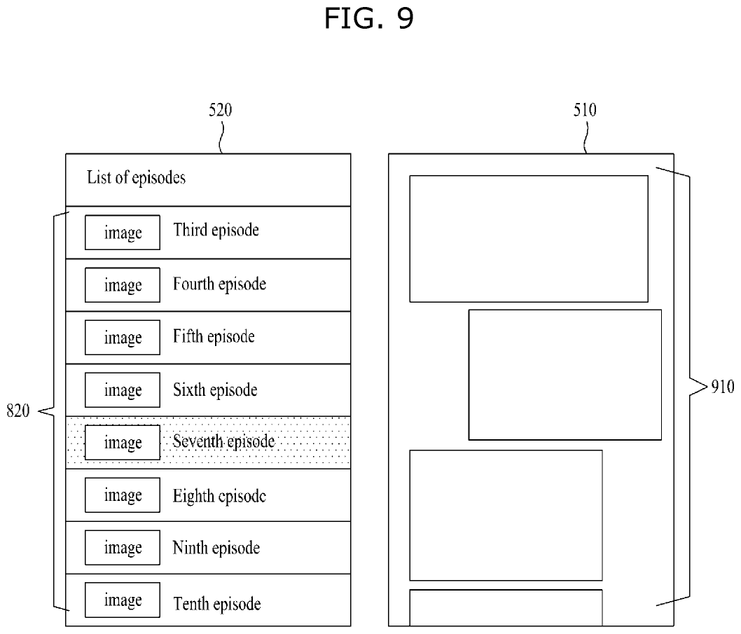

FIGS. 8 and 9 are exemplary diagrams for describing a process of highlighting, in an episode list, the episode item corresponding to the webtoon being watched according to an embodiment of the present disclosure.

For example, referring to FIG. 8, when the 6^{th} episode of a webtoon 810 is displayed on the main screen 510, the processor 212 may highlight the 6^{th} episode item, belong to the episode list 820 of the auxiliary screen 520, so that the 6^{th} episode item is different from other webtoon episode items on the episode list 820. When additional scrolling (e.g., scrolling from bottom to top) 801 is performed on the last scene of the 6^{th} episode of the webtoon 810, as illustrated in FIG. 9, the 6^{th} episode of the webtoon 810 may move onto the 7^{th} episode of the webtoon 910, and the 7^{th} episode of the webtoon 910 may be displayed on the main screen 510. At this time, the processor 212 may automatically move the highlight, indicative of a webtoon now being watched in the episode list 820 of the auxiliary screen 520, from the 6^{th} episode item to the 7^{th} episode item, and may highlight the 7^{th} episode item so that the 7^{th} episode item is different from other webtoon episode items on the episode list 820.

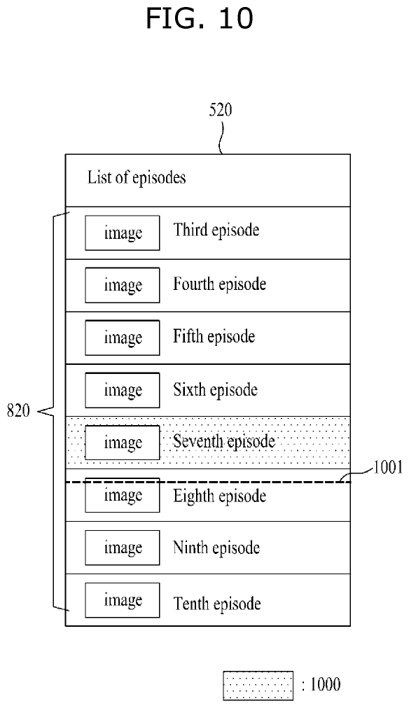

FIGS. 10 to 13 are exemplary diagrams for describing a process of controlling the highlighting of webtoon episode items in an episode list according to an embodiment of the present disclosure.

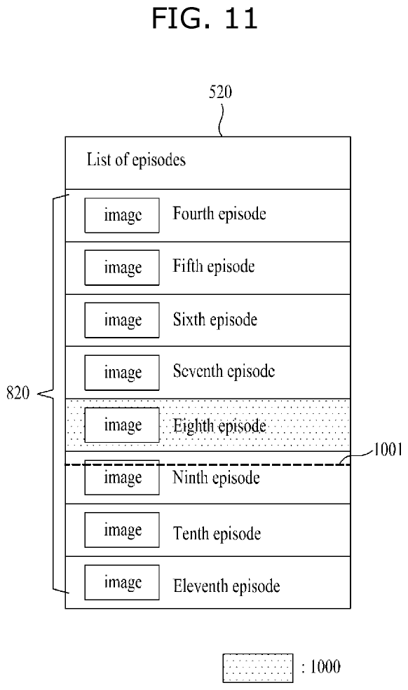

Referring to FIG. 10, the processor 212 may automatically adjust the scrolling of the episode list 820 so that a highlight 1000 indicative of a webtoon now being watched is positioned above the location of a first reference line 1001 virtually provided on the auxiliary screen 520. In other words, the processor 212 may adjust the highlight location by automatically scrolling the episode list 820 so that the highlight 1000 in the episode list 820 is not extended over, i.e., overlap, the first reference line 1001 or located below the first reference line 1001. For example, as illustrated in FIG. 10, if the 8^{th} episode of the webtoon is loaded onto the main screen 510 in the state in which the highlight 1000 has been located in the 7^{th} episode item, when the highlight 1000 moves to the 8^{th} episode item, the highlight 1000 may be extended over the first reference line 1001 or located below the first reference line 1001. Accordingly, as illustrated in FIG. 11, the processor 212 may automatically adjust the scrolling of the episode list 820 so that the highlight 1000 is located above the first reference line 1001 by upward scrolling the episode list 820.

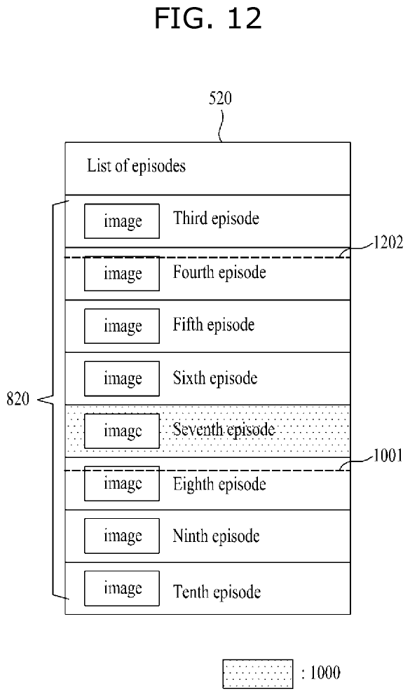

For another example, referring to FIG. 12, the processor 212 may automatically adjust the scrolling of the episode list 820 so that the highlight 1000 indicative of a webtoon now being watched is located between the first reference line 1001 and a second reference line 1202 virtually provided on the auxiliary screen 520. In other words, the processor 212 may adjust the highlight location by automatically scrolling the episode list 820 so that the highlight 1000 is located above the first reference line 1001 and below the second reference line 1202.

In this case, the processor 212 may move the highlight 1000 by one space at a time and then scroll the episode list 820 by a maximum length at the time at which the highlight 1000 reaches a critical location or may scroll the episode list 820 by a unit length whenever the highlight 1000 moves within a given range area. For example, when scrolling down a list of 10 items, the highlight 1000 may move down one episode item by one episode item in the order of the current episode list 820. When the highlight 100 reaches the threshold (i.e., the tenth episode item), the auxiliary screen 520 is scrolled by the length of 10 episode items to display the next episode list. In other words, the highlight 1000 scrolls through the episode list 820 in a unit length of 10 episode items. As another way of scrolling, when the highlight 1000 moves down one episode item by one episode item in the order of the current episode list 820, the episode list 820 may also scroll the length of each one episode item. As used here, one space means one episode item displayed on the episode list 820, the maximum length means the total length of the episode list 820 displayed on one auxiliary screen, the critical location means the scroll limit point, and the unit length means the length that can be scrolled once.

The location of the first reference line 1001 and the second reference line 1202 may be determined based on a ratio of the episode list 820 occupied in the auxiliary screen 520, the number of items constituting the episode list 820 (i.e., the number of items that can be displayed on one the auxiliary screen 520 as the episode list 820, or a ratio of each of items occupied in the auxiliary screen 520.

Accordingly, in order to increase the visibility of the highlight 1000 indicative of a webtoon now being watched on the auxiliary screen 520, within a valid area or a more effective area (i.e., within a more conspicuous area) among the areas on the auxiliar screen 520), the processor 212 may adjust the highlight location by automatically scrolling the episode list 820 so that the highlight 1000 is located within a given range using at least one reference line determined in the auxiliary screen 520.

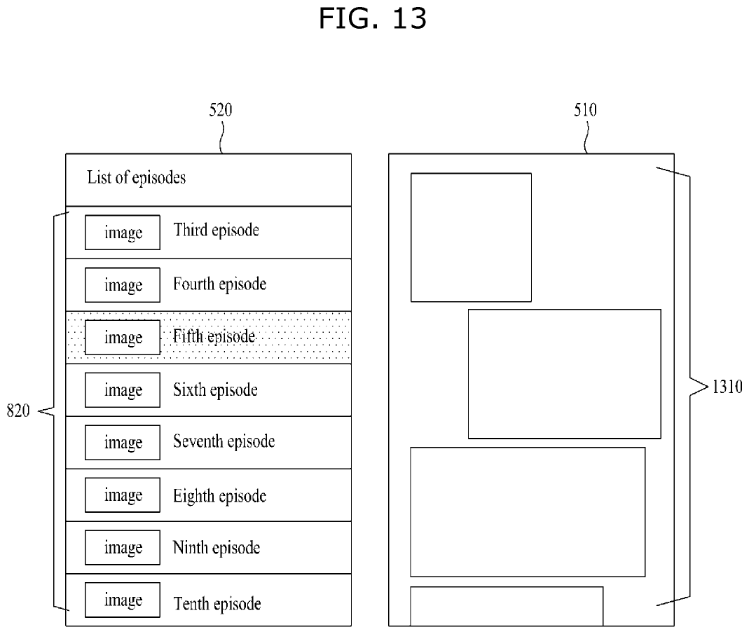

Furthermore, the processor 212 may scroll the episode list 820 in response to a scrolling input to the auxiliary screen 520 from a user, and may display, on the main screen 510, a webtoon 1310 selected by the user in the episode list 820. As illustrated in FIG. 13, the processor 212 may display, on the main screen 510, the webtoon 1310 selected in the episode list 820 of the auxiliary screen 520, and may highlight the selected webtoon item in the episode list 820.

When a user watches a specific webtoon episode on the main screen 510, the processor 212 highlights the corresponding webtoon episode item in the episode list 820 of the auxiliary screen 520. At this time, if the user searches the episode list 820 by scrolling the auxiliary screen 520 while watching a specific webtoon episode and then scrolls the main screen 510 again or if an additional scrolling input is not performed on the auxiliary screen 520 until a given time elapses, the processor 212 may adjust the highlight 1000 for the webtoon episode item now being watched so that the highlight 1000 is located within a reference line again by automatically scrolling the episode list 820. For example, if a user watches the 7^{th} episode of the webtoon, checks previous episodes or the remaining episodes by scrolling the episode list 820, and then watches the 7^{th} episode again, the processor 212 may adjust the highlight 1000 for the 7^{th} episode item by automatically scrolling the episode list 820 so that the highlight 1000 is located above a reference line or within two reference lines.

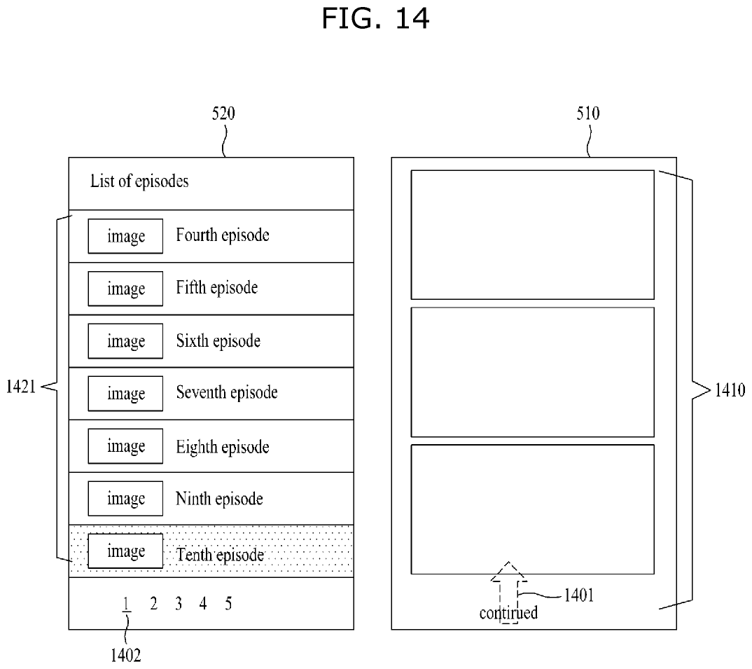

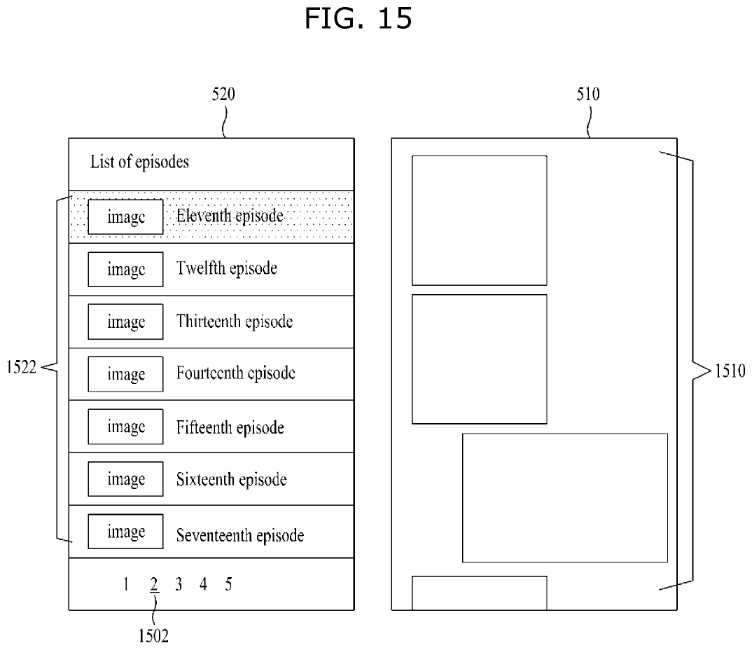

FIGS. 14 and 15 are exemplary diagrams for describing a process of displaying an episode list composed of a plurality of pages according to an embodiment of the present disclosure.

In some embodiment, an episode list may be composed of a plurality of pages. As illustrated in FIGS. 14 and 15, the processor 212 may display an episode list 1421, 1522 on the auxiliary screen 520 in a page unit.

For example, referring to FIG. 14, when the 10^{th} episode of the webtoon 1410 is displayed on the main screen 510, the processor 212 may highlight the 10^{th} episode item in the episode list 1421 of the auxiliary screen 520 so that the 10^{th} episode item is different from other webtoon episode items. In this case, the processor 212 may display, on the auxiliary screen 520, page information 1402 indicating that the episode list 1421 of the auxiliary screen 520 corresponds to any one of all pages.

When additional scrolling (e.g., scrolling from bottom to top) 1401 is performed in the last scene of the 10^{th} episode of the webtoon 1410, as illustrated in FIG. 15, the 10^{th} episode of the webtoon 1410 may directly move onto the 11^{th} episode of the webtoon 1510, and the 11^{th} episode of the webtoon 1510 may be displayed on the main screen 510. At this time, if the 10^{th} episode of the webtoon 1410 is the last webtoon in the episode list 1421, the processor 212 may display the 11^{th} episode of the webtoon 1510 on the main screen 1510, and may simultaneously display the episode list 1522 of the next page on the auxiliary screen 520. The processor 212 may highlight the 11^{th} episode item now being watched in the episode list 1522 so that the 11^{th} episode item is different from other webtoon episode items. Moreover, the processor 212 may also display, on the auxiliary screen 520, page information 1502 indicating that the episode list 1522 indicated as a page movement in the auxiliary screen 520 corresponds to any one of all pages. In other words, in the forward moving mode, when the last episode of the webtoon of the previous page episode list 1421 moves onto the next episode of the webtoon, the processor 212 may control an episode list so that the previous page episode list 1421 automatically moves onto the next page episode list 1522, in the same manner as a next page is selected.

As described above, according to the embodiments of the present disclosure, content can be displayed on one screen and an episode list can be displayed on the other screen of a dual screen. In particular, an episode list may be highlighted on the other screen with respect to content displayed on one screen.

The aforementioned device may be implemented by a hardware component, a software component and/or a combination of a hardware component and a software component. For example, the device and components described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor or any other device capable of executing or responding to an instruction. A processor may perform an operating system (OS) and one or more software applications executed on the OS. Furthermore, the processor may access, store, manipulate, process and generate data in response to the execution of software. For convenience of understanding, one processing device has been illustrated as being used, but a person having ordinary skill in the art may understand that the processor may include a plurality of processing elements and/or a plurality of types of processing elements. For example, the processor may include a plurality of processors or a single processor and a single controller. Furthermore, a different processing configuration, such as a parallel processor, is also possible.

Software may include a computer program, code, an instruction or a combination of one or more of them and may configure a processor so that it operates as desired or may instruct the processor independently or collectively. The software and/or data may be embodied in a machine, component, physical device, virtual equipment or computer storage medium or device of any type in order to be interpreted by the processor or to provide an instruction or data to the processor. The software may be distributed to computer systems connected over a network and may be stored or executed in a distributed manner. The software and data may be stored in one or more computer-readable recording media.

The method according to the embodiments may be implemented in the form of a program instruction executable by various computer means and stored in a computer-readable recording medium. In this case, the medium may continue to store a program executable by a computer or may temporarily store the program for execution or download. Furthermore, the medium may be various recording means or storage means of a form in which one or a plurality of pieces of hardware has been combined. The medium is not limited to a medium directly connected to a computer system, but may be one distributed over a network. An example of the medium may be one configured to store program instructions, including magnetic media such as a hard disk, a floppy disk and a magnetic tape, optical media such as CD-ROM and a DVD, magneto-optical media such as a floptical disk, ROM, RAM, and flash memory. Furthermore, other examples of the medium may include an app store in which apps are distributed, a site in which other various pieces of software are supplied or distributed, and recording media and/or store media managed in a server.

According to the embodiments of the present disclosure, content can be displayed on one screen and an episode list can be displayed on the other screen of a dual screen.

According to the embodiments of the present disclosure, an episode list may be highlighted on the other screen with respect to content displayed on the one screen.

According to the embodiments of the present disclosure, the other screen can be automatically scrolled and displayed when the one screen is scrolled by associating content and an episode list displayed on the dual screen.

As described above, although the embodiments have been described in connection with the limited embodiments and drawings, those skilled in the art may modify and change the embodiments in various ways from the description. For example, proper results may be achieved although the above descriptions are performed in order different from that of the described method, and/or the aforementioned components, such as the system, configuration, device, and circuit, are coupled or combined in a form different from that of the described method or replaced or substituted with other components or equivalents. Accordingly, other implementations, other embodiments, and equivalents of the claims fall within the scope of the claims.

What is claimed is:

1. A method of providing content executed in a computer device having at least one processor configured to execute computer-readable instructions included in a memory, the method comprising:
displaying, by the at least one processor, content on a first screen and a list of contents on a second screen of a dual screen included in the computer device; and
highlighting, by the at least one processor, a content item indicative of the content being displayed on the first screen in the list of contents in a forward moving mode in which content corresponding to the list of contents is continuously displayed on the first screen in response to a scrolling input to the first screen.

2. The method of claim 1, wherein the content on the first screen and the list of contents on the second screen are displayed through a web browser supporting a dual screen function.

3. The method of claim 1, wherein highlighting the item comprises moving the highlight in the list of contents from a previous item indicative of previous content to a next item indicative of next content, when the previous content moves onto the next content in response to the scrolling input to the first screen.

4. The method of claim 3, wherein highlighting the item comprises adjusting the list of contents by scrolling the list of contents so that the highlight is located within a given range using at least one reference line on the second screen.

5. The method of claim 3, wherein highlighting the item comprises scrolling the list of contents by a maximum length at timing at which the highlight in the list of contents reaches a critical location on the second screen.

6. The method of claim 3, wherein highlighting the item comprises scrolling the list of contents by a unit length when the highlight in the list of contents moves on the second screen.

7. The method of claim 3, wherein highlighting the item further comprises:
scrolling the list of contents in response to a scrolling input to the second screen; and
adjusting the list of contents by scrolling the list of contents so that the highlight is located within a given range using at least one reference line on the second screen, when an additional scrolling input for the second screen is not present for a given time or a scrolling input to the first screen is present.

8. The method of claim 1, further comprising:
displaying, by the at least one processor, the list of contents on the second screen in a page unit if the list of contents is composed of a plurality of pages; and
controlling, by the at least one processor, the list of contents on the second screen so that a previous page automatically moves onto a next page in the forward moving mode.

9. A non-transitory computer-readable recording medium storing a program which, when executed by a computer, causes the computer to perform the method of providing content according to claim 1.

10. A computer device comprising:
at least one processor implemented to execute computer-readable instructions included in a memory,
wherein the at least one processor comprises:
a display unit configured to display content on a first screen and a list of contents on a second screen of a dual screen included in the computer device; and
an association unit configured to highlight, in the list of contents, a content item indicative of the content being displayed on the first screen, in a forward moving mode in which content corresponding to the list of contents is continuously displayed on the first screen in response to a scrolling input to the first screen.

11. The computer device of claim 10, wherein the display unit displays the content on the first screen and displays the list of contents on the second screen, through a web browser supporting a dual screen function.

12. The computer device of claim 10, wherein the association unit moves the highlight in the list of contents from a previous item indicative of previous content to a next item indicative of next content, when the previous content moves onto the next content in response to the scrolling input to the first screen.

13. The computer device of claim 12, wherein the association unit adjusts the list of contents by scrolling the list of contents so that the highlight is located within a given range using at least one reference line on the second screen.

14. The computer device of claim 12, wherein the association unit scrolls the list of contents by a maximum length at timing at which the highlight in the list of contents reaches a critical location on the second screen.

15. The computer device of claim 12, wherein the association unit scrolls the list of contents by a unit length when the highlight in the list of contents moves on the second screen.

16. The computer device of claim 12, wherein the association unit scrolls the list of contents in response to a scrolling input to the second screen; and
adjusts the list of contents by scrolling the list of contents so that the highlight is located within a given range using at least one reference line on the second screen, when an additional scrolling input for the second screen is not present for a given time or a scrolling input to the first screen is present.

17. The computer device of claim 10, wherein:
the display unit displays the list of contents on the second screen in a page unit if the list of contents is composed of a plurality of pages, and
the association unit controls the list of contents on the second screen so that a previous page automatically moves onto a next page in the forward moving mode.
